(19) United States
(12) Patent Application Publication
(10) Pub. No.: US 2025/0106684 A1
(43) Pub. Date: Mar. 27, 2025

(54) ELECTRONIC DEVICE FOR TRANSMITTING FOR DATA AND OPERATION METHOD THEREOF

(71) Applicant: SAMSUNG ELECTRONICS CO., LTD., Suwon-si (KR)

(72) Inventors: Sungin SHIN, Suwon-si (KR); Seungbeom SEO, Suwon-si (KR); Junyoung CHOI, Suwon-si (KR)

(21) Appl. No.: 18/890,568

(22) Filed: Sep. 19, 2024

(30) Foreign Application Priority Data
Sep. 22, 2023 (KR) 10-2023-0127306

(51) Int. Cl. H04W 28/06; H04L 5/00; H04W 76/15

(52) U.S. Cl. CPC H04W 28/065; H04L 5/0053; H04W 76/15

(57) ABSTRACT

Various embodiments of the present disclosure relate to an electronic device for transmitting data and an operation method thereof Δn electronic device according to an embodiment of the present disclosure may include a communication circuit configured to support Bluetooth low energy (BLE), and at least one processor operatively connected to the communication circuit, wherein the at least one processor is configured to identify first data packets by dividing the same to correspond to the number of subevents, identify at least one first subevent and at least one second subevent in the divided subevents, update, based on an offset, the at least one first subevent and the at least one second subevent, and transmit, to an external electronic device, the first data packets included in the updated first subevent and the updated second subevent. In addition, various embodiments identified through the specification are also possible.

### CROSS-REFERENCE TO RELATED APPLICATION

This application is based on and claims priority under 35 U.S.C. § 119 to Korean Patent Application No. 10-2023-0127306, filed on Sep. 22, 2023, in the Korean Intellectual Property Office, the present disclosure of which is herein incorporated by reference in its entirety.

### BACKGROUND

### 1. Field

Various embodiments of the present disclosure relate to an electronic device for transmitting data and an operation method thereof.

### 2. Description of Related Art

A Bluetooth communication technology may support short-range wireless communication which enables electronic devices to be connected to each other for exchanging data or information. The Bluetooth communication technology may include a Bluetooth legacy (or classic) communication technology or a Bluetooth low energy (BLE or LE) communication technology, and may have various connection forms of topology such as piconet or scatternet.

ABLE isochronous channel function is a function of transmitting data between devices by using Bluetooth LE, and provides a method for transmitting and receiving data through time synchronization between the same source device and a sink device. Such a BLE isochronous channel function may operate based on connection-oriented communication, and may operate based on a connectionless communication.

Recently, electronic devices using a Bluetooth communication technology are widely used. Specifically, a pair of ear buds which can be worn on both ears of a user is widely used as an ear-wearable device. The ear-wearable device may provide various functions. For example, the ear-wearable device may include a microphone to identify a voice of the user, and may transmit data of the voice of the user to an electronic device (e.g., a smartphone). In addition, the ear-wearable device may include a speaker to output audio data received from an electronic device (e.g., a smartphone) through the speaker. For example, the ear-wearable device may transmit voice data to the electronic device through a connection with the electronic device, and the electronic device may output audio data (or audio content). Each audio data may be configured and managed as a connected isochronous group (CIG) event, and each audio data of the left and right sides of the ear-wearable device in one CIG event may be distinguished and managed as a connected isochronous stream (CIS). Such audio data may be output through the speaker.

Recently, there are an increasing number of electronic devices for providing CQ quality, high definition (HD) quality, or ultra-high quality (UHQ) lossless data. Accordingly, Bluetooth specifications of transmission of high capacity data such as high quality audio such as CD-quality lossless audio are being discussed.

The above information is presented as background information only to assist with an understanding of the present disclosure. No determination has been made, and no assertion is made, as to whether any of the above might be applicable as prior art with regard to the present disclosure.

### SUMMARY

There is a need in an amended isochronous stream scheme for connection-based BLE high speed transmission. In the present disclosure, more specifically, an electronic device for providing a data packet structure which enables data to be effectively transmitted for BLE high speed transmission and an operation method of the electronic device are required.

An embodiment of the present disclosure provides an electronic device for transmitting data and an operation method thereof.

The technical subjects pursued in the present disclosure may not be limited to the above-mentioned technical subjects, and other technical subjects which are not mentioned may be clearly understood from the following descriptions by those skilled in the art to which the present disclosure pertains.

An electronic device according to an embodiment of the present disclosure may include a communication circuit configured to support Bluetooth low energy (BLE) communication and at least one processor operatively connected to the communication circuit, wherein the at least one processor is configured to identify first data packets by dividing the same to correspond to the number of subevents, identify at least one first subevent and at least one second subevent in the divided subevents, update, based on an offset, the at least one first subevent and the at least one second subevent, and transmit, to an external electronic device, the first data packets included in the updated first subevent and the updated second subevent.

A method performed by an electronic device according to an embodiment of the present disclosure may include identifying first data packets by dividing the same to correspond to the number of subevents, identifying at least one first subevent and at least one second subevent in the divided subevents, updating, based on an offset, the at least one first subevent and the at least one second subevent, and transmitting, to an external electronic device, the first data packets included in the updated first subevent and the updated second subevent.

According to an embodiment of the present disclosure, an electronic device for transmitting data and an operation method thereof may be provided.

Advantageous effects obtainable from the present disclosure may not be limited to the above-mentioned effects, and other effects which are not mentioned may be clearly understood from the following descriptions by those skilled in the art to which the present disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an electronic device in a network environment according to an embodiment of the present disclosure;

FIG. 2 illustrates links between an electronic device and multiple external electronic devices according to an embodiment of the present disclosure;

FIG. 3 illustrates sequential arrangement of CIS events and subevents according to an embodiment of the present disclosure;

FIG. 4 illustrates interleaved arrangement of CIS events and subevents according to an embodiment of the present disclosure;

FIG. 5 illustrates a subevent according to an embodiment of the present disclosure;

FIG. 6 illustrates a subevent in a case of transmitting UHQ audio data according to an embodiment of the present disclosure;

FIG. 7 illustrates a subevent in a case of transmitting UHQ audio data according to an embodiment of the present disclosure;

FIG. 8 illustrates a subevent in a case of transmitting HD audio data according to an embodiment of the present disclosure;

FIG. 9 illustrates a parameter of a CIS event according to an embodiment of the present disclosure;

FIG. 10 illustrates a flowchart of an operation method of an electronic device according to an embodiment of the present disclosure;

FIG. 11 illustrates a configuration of an electronic device according to an embodiment of the present disclosure; and

FIG. 12 illustrates elements of an external electronic device according to an embodiment of the present disclosure.

With regard to the description of the drawings, the same or like reference signs may be used to designate the same or like elements.

### DETAILED DESCRIPTION

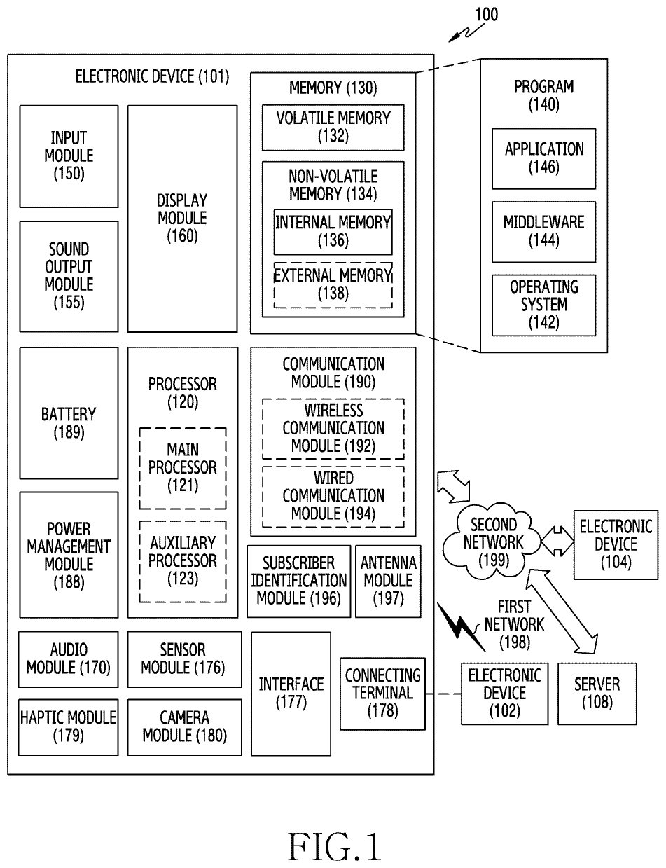

FIGS. 1 through 12, discussed below, and the various embodiments used to describe the principles of the present disclosure in this patent document are by way of illustration only and should not be construed in any way to limit the scope of the present disclosure. Those skilled in the art will understand that the principles of the present disclosure may be implemented in any suitably arranged system or device.

Hereinafter, embodiments of the present disclosure will be described in detail with reference to the accompanying drawings.

In describing the embodiments, descriptions related to technical contents well-known in the relevant art and not associated directly with the present disclosure will be omitted. Such an omission of unnecessary descriptions is intended to prevent obscuring of the main idea of the present disclosure and more clearly transfer the main idea.

For the same reason, in the accompanying drawings, some elements may be exaggerated, omitted, or schematically illustrated. Furthermore, the size of each element does not completely reflect the actual size.

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may be apparent, however, that such aspect(s) may be practiced without these specific details.

The terms used in the present disclosure are only used to describe specific embodiments, and may not be intended to limit the present disclosure. A singular expression may include a plural expression unless they are definitely different in a context. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

FIG. 1 illustrates an electronic device 101 in a network environment 100 according to an embodiment of the present disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment of the present disclosure, the electronic device 101 may communicate with the electronic device 104 via the server 108. According to an embodiment of the present disclosure, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment of the present disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the present disclosure, the processor 120 may include a main processor 121 (e.g., a central processing unit (CPU) or an application processor (AP)), or an auxiliary processor 123 (e.g., a graphics processing unit, a neural processing unit (NPU), an image signal processor, a sensor hub processor, or a communication processor) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment of the present disclosure, the auxiliary processor 123 (e.g., an image signal processor or a communication processor) may be implemented as part of another component (e.g., the camera module 180 or the communication module 190) functionally related to the auxiliary processor 123.

According to an embodiment of the present disclosure, the auxiliary processor 123 (e.g., the neural processing unit) may include a hardware structure specified for artificial intelligence model processing. The artificial intelligence model may be generated through machine learning. For example, such learning may be performed, by the electronic device 101 itself where the artificial intelligence model is performed or may also be performed via a separate server (e.g., the server 108). Learning algorithms may include, but are not limited to, for example, supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the present disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the present disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the present disclosure, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the present disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment of the present disclosure, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment of the present disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the present disclosure, the haptic module 179 may include, for example, a motor, a piezoelectric element, or an electric stimulator.

The camera module 180 may capture a still image or moving images. According to an embodiment of the present disclosure, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment of the present disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor) and supports a direct (e.g., wired) communication or a wireless communication. According to an embodiment of the present disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module).

A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be incorporated into a single component (e.g., a single chip), or may be implemented as multi components (e.g., multiple chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support high-speed transmission of high-capacity data (enhanced mobile broadband (eMBB)), terminal power minimization and multi-terminal access (massive machine type communications (mMTC)), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment of the present disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the present disclosure, the antenna module 197 may include an antenna including a radiating element composed of a conductive material or a conductive pattern formed in or on a substrate (e.g., a printed circuit board (PCB)). According to an embodiment of the present disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment of the present disclosure, another component (e.g., a radio frequency integrated circuit (RFIC)) other than the radiating element may be additionally formed as a part of the antenna module 197.

According to an embodiment of the present disclosure, the antenna module 197 may form a mmWave antenna module. According to an embodiment of the present disclosure, the mmWave antenna module may include a printed circuit board, a RFIC disposed at a first surface (e.g., the lower surface) of the printed circuit board or adjacent thereto and capable of supporting specified high-frequency bands (e.g., mmWave bands), and a plurality of antennas (e.g., an array antenna) disposed at a second surface (e.g., the upper or side surface) of the printed circuit board or adjacent thereto and capable of transmitting or receiving signals in the specified high-frequency bands.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the present disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the present disclosure, all or some of operations to be executed at the electronic device 101 may be executed at one or more of the external electronic devices 102, 104, or 108 (e.g., a server). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101.

The electronic device 101 may provide the outcome, with or without further processing of the outcome, as at least part of a reply to the request. To this end, a cloud computing, distributed computing, mobile edge computing (MEC), or client-server computing technology may be used, for example. The electronic device 101 may provide ultralow-latency services by using, for example, distributed computing or mobile edge computing. In another embodiment, the external electronic device 104 may include an internet-of-things (IoT) device. The server 108 may be an intelligent server using machine learning and/or a neural network. According to an embodiment of the present disclosure, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, or a home appliance. The electronic device according to embodiments of the present disclosure is not limited to those described above.

It should be appreciated that the embodiments and the terms used therein are not intended to limit the technological features set forth herein to particular embodiments and the present disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order). If an element (e.g., a first element) is referred to, with or without the term “operatively” or “communicatively,” as “coupled with/to” or “connected with/to” another element (e.g., a second element), it means that the element may be coupled/connected with/to the other element directly (e.g., wiredly), wirelessly, or via a third element.

As used in various embodiments of the present disclosure, the term “module” may include a unit implemented in hardware, software, or firmware, and may be interchangeably used with other terms, for example, “logic,” “logic block,” “component,” or “circuit.” The “module” may be a single integrated component, or a minimum unit or part thereof, adapted to perform one or more functions. For example, according to an embodiment of the present disclosure, the “module” may be implemented in the form of an application-specific integrated circuit (ASIC).

Various embodiments of the present disclosure may be implemented as software (e.g., the program or the electronic device 101) including one or more instructions that are stored in a storage medium (e.g., the internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions each may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

Methods according to an embodiment of the present disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in another element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration. According to various embodiments, operations performed by the module, the program, or another element may be carried out sequentially, in parallel, repeatedly, or heuristically, or one or more of the operations may be executed in a different order or omitted, or one or more other operations may be added.

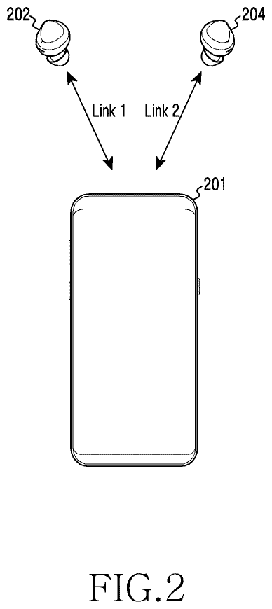

FIG. 2 illustrates links between an electronic device and multiple external electronic devices according to an embodiment of the present disclosure.

Referring to FIG. 2, an electronic device 201 may be a master device or a source device for providing data (e.g., audio data or multimedia data). The electronic device 201 may be an electronic device such as a smartphone or may be the electronic device of FIG. 1. According to an embodiment of the present disclosure, electronic device #1 202 and electronic device #2 204 may be slave devices or sink devices capable of receiving data from the electronic device 201 and processing or outputting the received data. Each of external electronic device #1 202 and external electronic device #2 204 may be the electronic device 102 or the electronic device 104 of FIG. 1.

The electronic device 201 and external electronic device #1 202 or the electronic device 201 and external electronic device #2 204 may be connected to each other based on a wireless communication technology (e.g., a Bluetooth legacy (or classic) or a Bluetooth low energy (BLE) communication technology) and perform data transmission and reception.

In various embodiments described below, a case where the electronic device 201 transmits data to two external electronic devices 202 and 204 is described. For example, the electronic device 201 may transmit, to external electronic device #1 202 and/or external electronic device #2 204, sound data which can be provided to a user.

According to an embodiment of the present disclosure, external electronic device #1 202 and/or external electronic device #2 204 may be devices included in a single set. For example, devices included in a single set may be devices which are connected through separate communication links, respectively, and provide a related function to provide one integrated service (e.g., stereo sound output or 5.1 channel sound output). For example, external electronic device #1 202 and external electronic device #2 204 may be wireless earphone devices operating as one set. In addition, external electronic device #1 202 may be one of a left external device and a right external device, and external electronic device #2 204 may be the other of the left external device and the right external device. In an embodiment, when external electronic device #1 202 and external electronic device #2 204 are implemented as wireless earphones, each of external electronic device #1 202 and/or external electronic device #2 204 may receive various data (e.g., data for synchronization of sound which can be output from a wireless earphone, data for sound adjustment, or a response signal corresponding to a signal transmitted by the electronic device 201).

In FIG. 2, an example in which the electronic device 201 is connected to two external electronic devices 202 and 204 is described, but the present disclosure is not limited thereto, and the electronic device 201 may be connected to three or more external electronic devices. In addition, various embodiments may be applied to devices receiving data transmitted by the external electronic device 201, such as not only external devices but also other types of devices capable of performing wireless communication with the electronic device 201, for example, a smartphone, a smart watch, or a tablet PC.

According to an embodiment of the present disclosure, the electronic device 201 may configure a first communication link (link 1) to perform data communication with external electronic device #1 202. In an embodiment, the electronic device 201 may configure a second communication link (link 2) to perform data communication with external electronic device #2 204. In addition, external electronic device #1 202 and/or external electronic device #2 204 may be also additionally connected through a separate third communication link (not shown), if necessary.

According to an embodiment of the present disclosure, connection-oriented communication may be performed through the first communication link and the second communication link. In addition, connectionless communication may be also performed between the electronic device 201 and external electronic device #1 202 and external electronic device #2 204. The connection-oriented communication and the connectionless communication may be also performed through isochronous (ISO) channels.

According to an embodiment of the present disclosure, the electronic device 201 may receive various information (e.g., connection device information and/or device attribute information) from external electronic device #1 202 and/or external electronic device #2 204, and provide, based on the received information, various user interfaces (e.g., a notification or control interface) through a display (e.g., the display module 160 of FIG. 1).

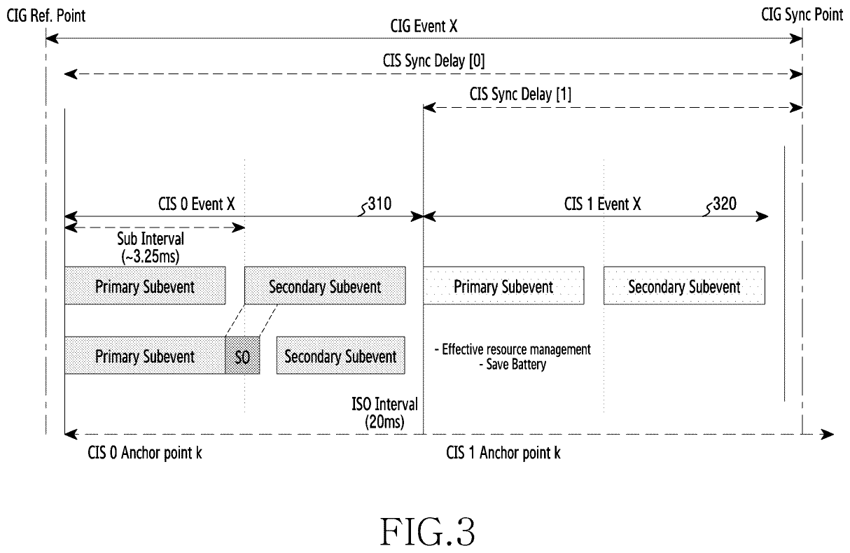

FIG. 3 illustrates sequential arrangement of connected isochronous stream (CIS) events and subevents according to an embodiment of the present disclosure.

Data to be transmitted from an electronic device to an external electronic device includes multiple connected isochronous stream (CIS) events, and the multiple CIS events may be configured and managed as a connected isochronous group (CIG) event. The CIG event is a bundle of CISs that provide the same service, and the CIG may include one or more CIS events. The CIS events included in the CIG event may have a common timing reference with reference to timing of a master device, and may be synchronized in units of time. For example, CIS events included in one CIG event may have the same ISO interval, and up to 31 CIS may be included in one CIG.

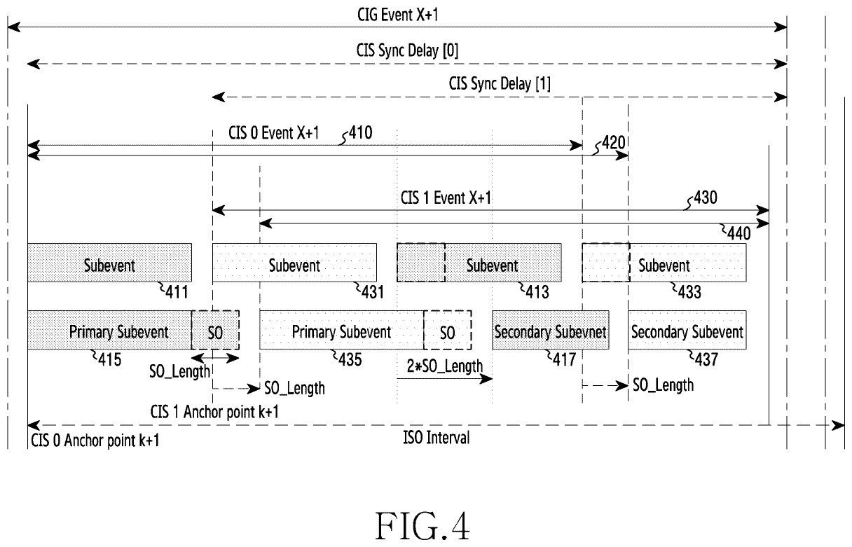

CIS events in each CIG event may be arranged according to in a sequential scheme or an interleaved scheme according to a subevent interval (sub interval) and an interval between CIS anchor points. For example, FIG. 3 is a case where CIS events are sequentially arranged, and FIG. 4 illustrates a case where CIS events are arranged in an interleaved scheme. In FIG. 3, the respective CIS events may not overlap and may be arranged in the sequence of CIS 0, CIS 1, . . . , and CIS N.

According to an embodiment of the present disclosure, two CIS events included in one CIG event may each include audio data transferred when an ear wearable device is connected to the electronic device. For example, referring to FIG. 3, data may be configured as CIS 0 event 310 and CIS 1 event 320, and CIS 0 event 310 and CIS 1 event 320 may be configured as a CIG event. CIS 0 event 310 may be, for example, audio data transferred to a left earbud when an external electronic device to which the electronic device is to transmit data is an ear wearable device, and CIS 1 event 320 may be audio data transferred to a right earbud.

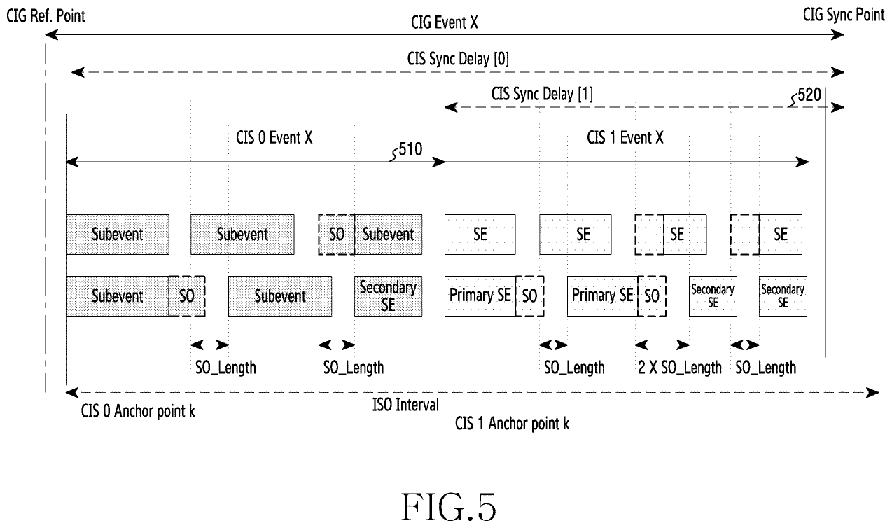

Data to be transferred from the electronic device to the external electronic device may be divided into multiple subevents. The number of subevents may be pre-configured, and may be also referred to as the number of subevents (NSE). Intervals of the respective subevents may be identical, and for example, the subevent interval of the multiple subevents may be configured as an interval of 3.25 ms. According to an embodiment of the present disclosure, subevents included in one CIS event may be classified as a primary subevent or a secondary subevent according to an order. For example, in FIG. 3, CIS 0 event 310 may include two subevents, the first subevent between the two subevents may be configured as a primary subevent, and the second subevent may be configured as a secondary subevent. A method for distinguishing between the primary subevent and the secondary subevent will be described in detail in FIG. 5.

The electronic device may determine a secondary offset (SO) to be transferred from the secondary subevent to the primary subevent. The SO may mean an amount of data transferred from the secondary subevent to the primary subevent, and the length of the SO may mean the length of a subevent to receive data to be transferred from the secondary subevent to the primary subevent. According to an embodiment of the present disclosure, the electronic device may reduce the length of the secondary subevent by the determined SO, increase the length of the primary subevent by the determined SO, and update the primary subevent and the secondary subevent. Accordingly, the primary subevent and the secondary subevent may not have the same length, and the amounts of data included in the primary subevent and the secondary subevent may be different.

According to an embodiment of the present disclosure, the length of the SO may be determined in consideration of the length of a subevent, a value corresponding to a partial ratio unit of the length of the subevent (e.g., 0.05 ( 1/20) or 0.1 ( 1/10)), or a value of the number of corresponding ratio units to be transmitted (e.g., 4 bits or 3 bits). The length of the subevent may mean the length of the same subevent before the updating of the primary event and the secondary event, and may be a value predetermined by the electronic device. The length of the subevent may be also referred to as, for example, subevent spacing.

Referring to FIG. 3, subevents included in CIS 0 event 310 may be divided into a primary subevent and a secondary subevent, respectively, and the electronic device may update each of the subevents by adding the length of the determined SO to the primary subevent and subtracting the length of the SO from the secondary subevent. The updated primary subevent and secondary subevent may include data to be transmitted from the electronic device to the external electronic device. For example, the updated primary subevent may include more amount of data than the updated secondary subevent and the data may be transmitted.

According to an embodiment of the present disclosure, when audio data is transmitted by changing the lengths of subevents through the SO, resource use can be efficiently performed through adaptive subevent change according to a format of the audio data. For example, all data packets to be transmitted may be included in one subevent, so that waste of resources for data transmission can be reduced, and complexity in a data format recombination and recoupling process can be reduced. In addition, when audio data is included in a variable subevent and transmitted, there may be a rest state corresponding to the subevent. Unnecessary waste of resources for data transmission can be reduced, a transmission success rate of audio data can be increased while maintaining low latency, and current consumption can be minimized.

FIG. 4 illustrates interleaved arrangement of CIS events and subevents according to an embodiment of the present disclosure.

Referring to FIG. 4, a case where CIS events are in interleaved arrangement is illustrated. When the CIS events are in interleaved arrangement, some of the CIS events may be overlapped.

As illustrated in FIG. 3, data to be transmitted from the electronic device to the external electronic device may be divided into multiple subevents. Intervals of the respective subevents may be identical, and for example, the subevent interval of the multiple subevents may be configured as an interval of 3.25 ms. According to an embodiment of the present disclosure, subevents included in one CIS event may be classified as a primary subevent or a secondary subevent according to an order. For example, in FIG. 4, CIS 0 event 410 may include two subevents 411 and 413, the subevent 411 in the first order between the two subevents 411 and 413 may be configured as a primary subevent, and the subevent 415 in the second order may be configured as a secondary subevent. In another example, in FIG. 4, CIS 1 event 430 includes two subevents 431 and 433, the subevent 431 in the first order between the two subevents 431 and 433 may be configured as a primary subevent, and the subevent 433 in the second order may be configured as a secondary subevent. A method for distinguishing between the primary subevent 411 and the secondary subevent 415 will be described in detail in FIG. 5.

The electronic device may determine a secondary offset (SO) to be transferred from the secondary subevent to the primary subevent. The SO may mean an amount of data transferred from the secondary subevent to the primary subevent, and the length of the SO may mean the length of a subevent to receive data to be transferred from the secondary subevent to the primary subevent.

According to an embodiment of the present disclosure, the electronic device may reduce the length of the secondary subevent by the determined SO, increase the length of the primary subevent by the determined SO, and update the primary subevent and the secondary subevent. That is, the primary subevent and the secondary subevent may not have the same length, and the lengths may be changed according to the SO.

According to an embodiment of the present disclosure, the length of the SO may be determined in consideration of the length of a subevent, a value corresponding to a partial ratio unit of the length of the subevent (e.g., 0.05 ( 1/20) or 0.1 ( 1/10)), or a value of the number of corresponding ratio units to be transmitted (e.g., 4 bits or 3 bits). The length of the subevent may mean the length of the same subevent before the updating of the primary event and the secondary event, and may be a value predetermined by the electronic device. The length of the subevent may be also referred to as, for example, subevent spacing.

Referring to FIG. 4, the electronic device may update each of the subevents by adding the length of the determined SO to the primary subevent in the CIS 0 event and subtracting the length of the SO from the secondary subevent. The length of CIS 0 event 420 including the updated primary subevent 411 and secondary subevent 417 may become longer than that of CIS 0 event 410 before updating of the subevent. Data to be transmitted from the electronic device to the external electronic device may be included. In addition, the electronic device may update each of the subevents by adding the length of the determined SO to the primary subevent 431 in CIS 0 event and subtracting the length of the SO from the secondary subevent 433. The length of CIS 1 event 440 including the updated primary subevent 435 and secondary subevent 437 may become longer than that of CIS 1 event 430 before updating of the subevent.

The CIS events 420 and 440 including the updated subevents may include data to be transmitted from the electronic device to the external electronic device, and data may be configured according to the lengths of the updated subevents.

FIG. 5 illustrates a subevent according to an embodiment of the present disclosure. Specifically, a method for determining a primary subevent and a secondary subevent among subevents is illustrated.

Referring to FIG. 5, CIS 0 event 510 and CIS 1 event 520 included in one CIG event are illustrated. Multiple subevents may be included in each CIS event, and the number of multiple subevents included in each CIS event may be an odd number or an even number. For example, in FIG. 5, a total of three subevents, which is an odd number, may be included in CIS 0 events 510, and a total of four subevents, which is an even number, may be included in CIS 1 event 520.

According to an embodiment of the present disclosure, the electronic device may define a primary subevent and a secondary subevent according to whether the number of subevents included in each CIS event is an odd number or an even number. According to an embodiment of the present disclosure, when the number of subevents is an odd number, subevents preceding a subevent in the middle order may be defined as primary subevents with reference to the subevent in the middle order. In addition, subevents that are subsequent to the subevent in the middle order may be defined as secondary subevents. For example, when a total number of subevents in CIS 0 event 510 in FIG. 5 is three corresponding to an odd number, the first subevent preceding the second subevent may be defined as a primary subevent with reference to the second subevent in the middle order. In addition, the third subevent that is subsequent to the second order may be defined as a secondary subevent. Accordingly, when the number of subevents is an odd number, the primary subevents and the secondary subevents defined with reference to the subevent in the middle order may be updated based on a value of an SO determined by the electronic device. For example, the primary subevents and the secondary subevents of CIS 0 event 510 in FIG. 5 may be updated based on the value of the SO determined by the electronic device. For example, some of the subevents included in CIS 0 event 510 may be defined as a primary subevent and a secondary subevent, the length of the primary subevent may be increased by the length of the SO determined by the electronic device, and the length of the secondary subevent may be reduced by the length of the SO.

Accordingly, when the number of subevents is an odd number, the primary subevents and the secondary subevents defined with reference to the subevent in the middle order may be updated based on the value of the SO determined by the electronic device. For example, the primary subevent and the secondary subevent of CIS 0 event 510 in FIG. 5 may be updated according to the SO determined by the electronic device. For example, some of the subevents included in CIS 0 event 510 may be defined as a primary subevent and a secondary subevent, the length of the primary subevent may be increased by the length of the SO determined by the electronic device, and the length of the secondary subevent may be reduced by the length of the SO.

According to another embodiment of the present disclosure, when the number of subevents is an even number, as many preceding subevents as a half of a total number of subevents may be defined as primary subevents with reference to the half of the total number of subevents. In addition, as many subsequent subevents as a half of a total number of subevents may be defined as secondary subevents. For example, when a total number of subevents in CIS 1 event 520 in FIG. 5 is four corresponding to an even number, the first and second subevents corresponding to the first two subevents may be defined as primary subevents with reference to two (4/2) corresponding to a half of the total number of subevents. In addition, the third and fourth subevents corresponding to the last two subevents may be defined as secondary subevents. Accordingly, when the number of subevents is an even number, the primary subevents and the secondary subevents defined with reference to the half of the total number of subevents may be updated by a value of an SO determined by the electronic device.

For example, the primary subevents and the secondary subevents of CIS 1 event 520 in FIG. 5 may be updated by the SO determined by the electronic device. For example, some of the subevents included in CIS 1 event 520 may be defined as a primary subevent and a secondary subevent, the length of the primary subevent may be increased by the length the SO determined by the electronic device, and the length of the secondary subevent may be reduced by the length of the SO.

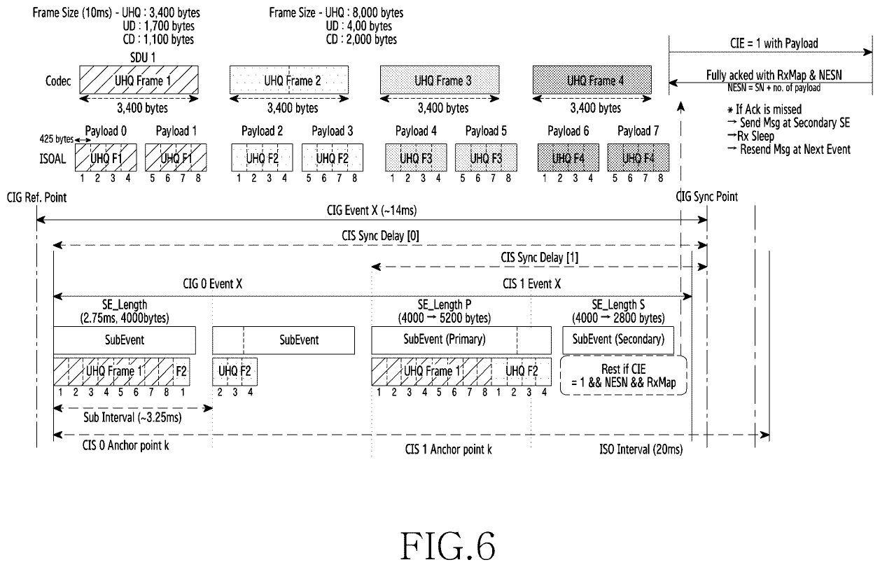

FIG. 6 illustrates a subevent in a case of transmitting ultra-high quality (UHQ) audio data according to an embodiment of the present disclosure.

UHQ audio refers to a 96 kHz/24-bit audio packet, and may have more than twice as much amount of data than 44.1 kHz/16-bit corresponding to an audio format generally used. FIG. 6 illustrates an example of configuring a data packet payload of UHQ audio. For example, the size of a frame of UHQ audio data may be about 3400 bytes. The size of the frame of the UHQ audio data may mean the size of a frame having the length of 10 ms, which can be processed by a codec.

Referring to FIG. 6, a CIG event may include a CIS 0 event and a CIS 1 event. In an example, data configuration in the CIS 0 event shows a case where data may be configured with subevents having the same length, without updating, based on the SO, the subevents. For example, with respect to audio data in the CIS 0 event, when the number of subevents is two (NSE=2), audio data may be configured with the same subevent, the size of which is 4,000 bytes. In this case, when the amount of audio data to be transmitted exceeds the amount of data that the first subevent in the CIS 0 event can receive, the exceeding amount of data may be included in the second subevent.

In another example, data configuration in the CIS 1 event shows a case where the subevents are updated based on the SO and data may be configured with the subevents having different lengths. For example, when the number of subevents is two in the CIS 1 event, an SO to change the length of the same subevent having the size of 4,000 bytes is applied so that the length of the subevent can be changed. Referring to FIG. 6, when two subevents included in the CIS 1 event follow the description in FIG. 5, the first subevent may be defined as a primary subevent, and the second subevent may be defined as a secondary subevent. With respect to the primary subevent and the secondary subevent, the length of the primary subevent may be increased and the length of the secondary subevent may be reduced according to the SO determined by the electronic device. For example, when the SO is determined to be 1,200 bytes, the primary subevent may be increased from 4,000 bytes to 5,200 bytes, and the secondary subevent may be reduced from 4,000 bytes to 2,800 bytes.

In this case, audio data to be transmitted in the CIS 1 event may be all received in the primary subevent. When audio data to be transmitted in the CIS 1 event is all received in the primary subevent and transmitted and an acknowledgement (ACK) according to the transmission of the data is received, the secondary subevent may enter into a rest state without receiving the audio data. In another example, even when audio data to be transmitted in the CIS 1 event is all received in the primary subevent and transmitted but the acknowledgement (ACK) according to the transmission of the data is not received, the electronic may identify, through a close isochronous event (CIE) identifier indicating whether a CIS event ends early, that the data transmission through the CIS event has been all completed, and the secondary subevent may enter into a rest state.

According to an embodiment of the present disclosure, an operation of processing audio data by the electronic device may be performed in a data processing layer, and the data processing layer may include an isochronous adaptation layer (ISOAL). The ISOAL may provide segmentation, fragmentation, reassembly, and recombination services to transmit audio data to an upper layer or to a lower layer. For example, in the ISOAL, a payload may be processed according to a UHQ audio data frame.

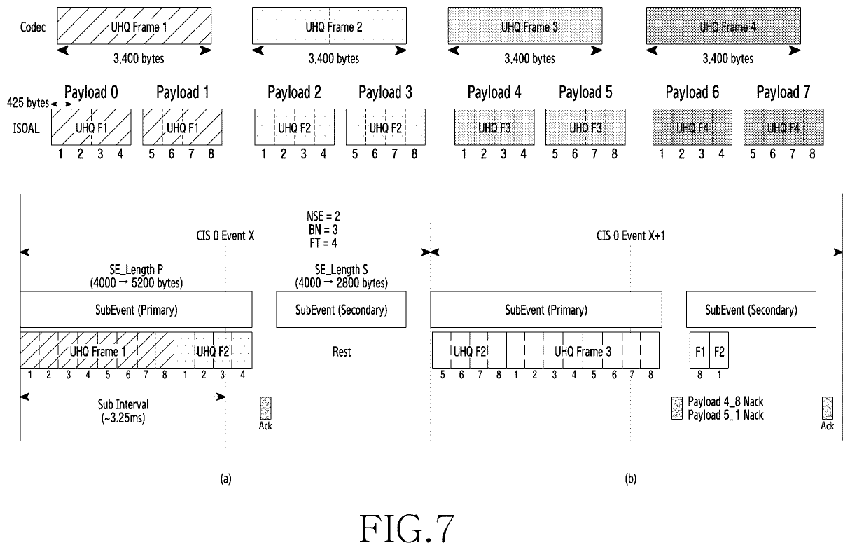

FIG. 7 illustrates a subevent in a case of transmitting UHQ audio data according to an embodiment of the present disclosure.

FIG. 7 illustrates a case of configuring data to be transmitted after defining a primary subevent and a secondary subevent and then updating the primary subevent and the secondary subevent according to an SO.

Referring to FIG. 7, a case of (a) for a CIS 0 event shows a case where data is configured through a primary event and a secondary event updated according to an SO, data to be transmitted is all transmitted to the updated primary event, and an ACK is received. The case of (a) may correspond to, for example, the case of the CIS 1 event in FIG. 6. For example, when the SO is determined to be 1,200 bytes, the primary subevent may be increased from 4,000 bytes to 5,200 bytes, and the secondary subevent may be reduced from 4,000 bytes to 2,800 bytes. In this case, audio data to be transmitted may be all received in the primary subevent. When audio data to be transmitted is all received in the primary subevent and an acknowledgement (ACK) according to the transmission of the data is received, the secondary subevent may enter into a reset state without receiving the audio data.

Referring to FIG. 7, a case of (b) for the CIS 0 event shows a case where data is configured through a primary event and a secondary event updated according to an SO and data to be transmitted is all transmitted to the updated primary event, but a non-acknowledgement (NACK) is received for a part of a data payload. For example, when audio data to be transmitted is all received in the primary subevent and transmitted and a NACK is received for a specific payload, the secondary subevent may retransmit the audio data for which the NACK has been received.

According to an embodiment of the present disclosure, an operation of processing audio data by the electronic device may be performed in a data processing layer, and the data processing layer may include an isochronous adaptation layer (ISOAL). The ISOAL may provide segmentation, fragmentation, reassembly, and recombination services to transmit audio data to an upper layer or to a lower layer. For example, in the ISOAL, a payload may be processed according to a UHQ audio data frame.

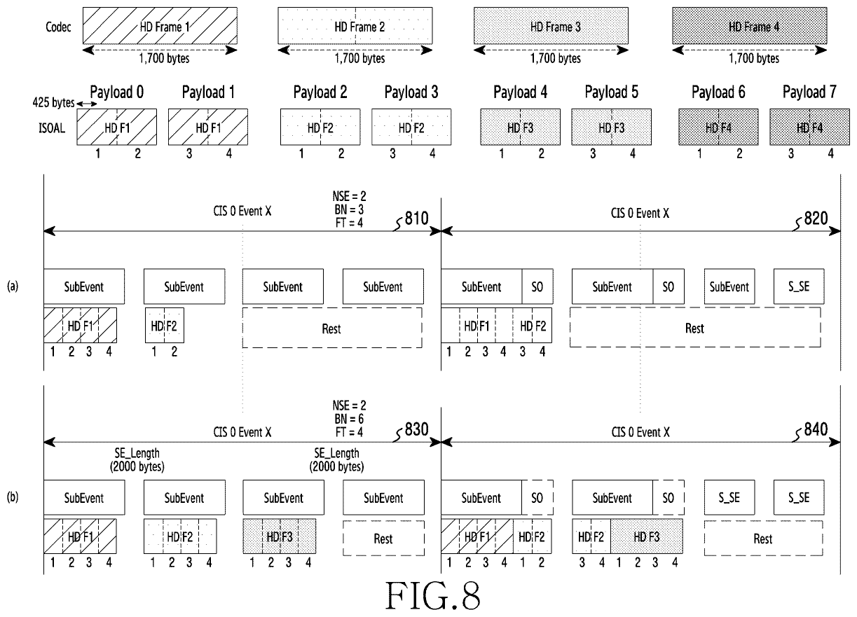

FIG. 8 illustrates a subevent in a case of transmitting high definition (HD) audio data according to an embodiment of the present disclosure. Part (a) of FIG. 8 and part (b) of FIG. 8 illustrate different examples.

HD audio refers to a 48 kHz/24-bit audio packet. FIG. 8 illustrates an example of configuring a data packet payload of HD audio. For example, the size of a frame of HD audio data may be about 1,700 bytes. The size of the frame of the HD audio data may mean the size of a frame having the length of 10 ms, which can be processed by a codec.

Case (a) of FIG. 8 illustrates a case where the number of subevents is four (NSE=2) and the number of payloads which can be transmitted from one subevent is three. The number of payloads which can be transmitted in one event may be referred as a burst number (BN). Referring to case (a) of FIG. 8, when the BN is three, one CIS event may include data corresponding to payload 2 of HD frame 1 and HD frame 2 of FIG. 8. Referring to case (a) of FIG. 8, when data is configured with subevents having the same length without updating, based on an SO, the subevents (810), audio data may be received in identical subevents each corresponding to 2,000 bytes and transmitted. In an example, when data is configured with subevents having the same length without updating, based on an SO, the subevents (810), all data is included in the first and second subevents and transmitted. When an ACK is received, the remaining third and fourth subevents may not receive audio data and may enter into a rest state.

On the other hand, in another example, when subevents are updated based on the SO and data is configured with subevents having different lengths (820), data may be configured in subevents obtained by applying the SO for changing the length to identical subevents each corresponding to 2,000 bytes. According to the description of FIG. 5, the first and second subevents may be defined as primary subevents, and the third and fourth subevents may be defined as secondary subevents. Audio data to be transmitted may be all received in the first subevent among the primary subevents having an increased length. In this case, when audio data is all received in the first subevent and transmitted and an acknowledgement (ACK) according to the transmission of the data is received, the second and fourth subevents may not receive audio data and may enter into a rest state.

Case (b) of FIG. 8 illustrates a case where the NSE is four and the BN is six. Referring to case (b) of FIG. 8, when the BN is six, data corresponding to HD frame 1 to HD frame 3 of FIG. 8 may be included in one CIS event. Referring to part (b) of FIG. 8, when data is configured with subevents having the same length without updating, based on an SO, the subevents (830), audio data may be received in identical subevents each corresponding to 2,000 bytes and transmitted. In an example, when data is configured with subevents having the same length without updating, based on an SO, the subevents (830), all data is included in the first to third subevents and transmitted. When an ACK is received, the remaining fourth subevent may not receive audio data and may enter into a rest state. On the other hand, in another example, when subevents are updated based on the SO and data is configured with subevents having different lengths (840), data may be configured in subevents obtained by applying the SO for changing the length to identical subevents each corresponding to 2,000 bytes.

According to the description of FIG. 5, the first and second subevents may be defined as primary subevents, and the third and fourth subevents may be defined as secondary subevents. Audio data to be transmitted may be all received in the primary subevents having an increased length. In this case, when audio data is all received in the first and second subevents corresponding to the primary subevents and transmitted and an acknowledgement (ACK) according to the transmission of the data is received, the third and fourth subevents may not receive audio data and may enter into a rest state.

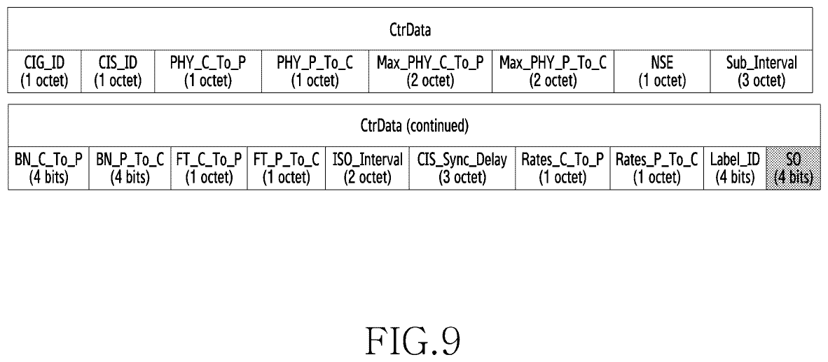

FIG. 9 illustrates a parameter of a CIS event according to an embodiment of the present disclosure.

Each CIS event may be defined by various parameters. Referring to FIG. 9, for example, a parameter configured by the first external electronic device 201 when a CIS event is generated may include CIG_ID, CIS_ID, PHY_C_To_P, PHY_P_To_C, Max_PDU_C_To_P, Max_PDU_P_To_C, NSE, SDU_Interval, Sub_Interval, BN_C_To_P, BN_P_To_C, FC_C_To_P, FC_P_To_C, ISO_Interval, CIS_Sync_Delay, Rates_C_To_P, Label_ID, or a reserve for future use (RFU). However, according to an embodiment of the present disclosure, an RFU bit may be used as, for example, the secondary offset (SO) described in FIGS. 3 to 9. Accordingly, referring to FIG. 9, the parameter configured by the first external electronic device when the CIS event is generated may include a 4-bit SO. The CIG_ID means a CIG identifier. The CIS_ID means a CIS identifier. The PHY_C_To_P means PHY used to transmit a packet from the central to the peripheral. The PHY_P_To_C means PHY used to transmits a packet from the peripheral to the central. The Max_SDU_C_To_P means a maximum size of a PDU in units of octets transmitted from the central to the peripheral. The Max_PDU_P_To_C means a maximum size of a PDU in units of octets transmitted from the peripheral to the central. In addition, the Sub_Interval means a time interval between starts of two consecutive subevents of a CIS. The ISO_Interval means a time interval between CIS anchor points of an adjacent CIS event. The NSE means a maximum number of subevents of each CIS event. Such parameters may be changed through a series of processes.

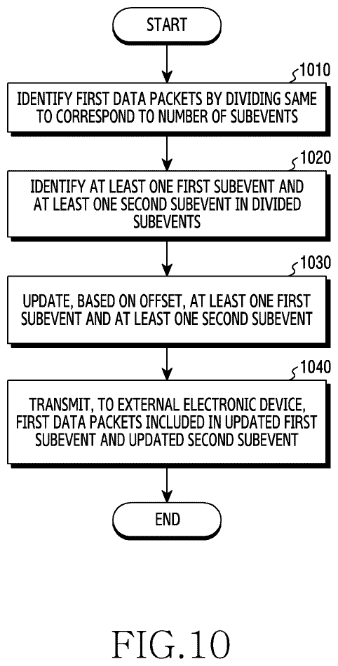

FIG. 10 illustrates a flowchart of an operation method of an electronic device according to an embodiment of the present disclosure.

Referring to FIG. 10, in operation 1010, an electronic device may identify first data packets by dividing the same to correspond to the number of subevents. The first data packets may mean data included in one CIS event. The first data packets may correspond to data included in, for example, the CIS 0 event of FIG. 3. According to an embodiment of the present disclosure, the electronic device may divide the first data packets according to a preconfigured number of subevents. For example, in relation to data included in the CIS 0 event of FIG. 3, when the preconfigured number of subevents is two, data included in the CIS 0 event may be configured to be divided into two subevents.

In operation 1020, the electronic device may identify at least one first subevent and at least one second subevent in the divided subevents. The first subevent may mean, for example, the primary subevent described in FIGS. 3 to 8, and the second subevent may mean, for example, the secondary subevent described in FIGS. 3 to 8. The electronic device may identify the first subevent and the second subevent to change the length among the respective subevents, in relation to the data packets divided according to the pre-configured number of subevents in operation 1010.

According to an embodiment of the present disclosure, when the number of subevents is an odd number, the electronic device may identify the first subevent and the second subevent with reference to a subevent in the middle order. Specifically, when the number of subevents is an odd number, the electronic device may define subevents preceding the subevent in the middle order as primary subevents. In addition, the subevents subsequent to the subevent in the middle order may be defined as secondary subevents. For example, when a total number of subevents in CIS 0 event 510 of FIG. 5 is three corresponding to an odd number, the first subevent preceding the second subevent may be defined as a primary subevent with reference to the second subevent corresponding to the middle order. In addition, the third subevent subsequent to the second order may be defined as a secondary subevent.

According to another embodiment of the present disclosure, when the number of subevents is an even number, the first subevent and the second subevent may be identified with reference to a half of the number of subevents. Specifically, when the number of subevents is an even number, the electronic device may define the subevents corresponding to a half of a total number of preceding subevents as primary subevents with reference to the half of the total number of subevents. In addition, the subevents corresponding to a half of a total number of subsequent subevents may be defined as secondary subevents. For example, when a total number of subevents in CIS 1 event 520 of FIG. 5 is four corresponding to an even number, the first and second subevents corresponding to the first two subevents may be defined as primary subevents with reference to two (4/2) corresponding to a half of the total number of subevents. In addition, the third and fourth subevents corresponding to the last two subevents may be defined as secondary subevents.

In operation 1030, the electronic device may update, based on an offset, the at least one first subevent and the at least one second subevent.

The offset may mean an amount of data transferred from the second subevent to the first subevent. Specifically, the length of the offset may mean the length of a subevent to receive data to be transferred from the second subevent to the first subevent. The offset may mean, for example, the secondary offset (SO) described in FIG. 3. According to an embodiment of the present disclosure, the length of the SO may be determined in consideration of the length of a subevent, a value corresponding to a partial ratio unit of the length of the subevent (e.g., 0.05 ( 1/20) or 0.1 ( 1/10)), or a value of the number of corresponding ratio units to be transmitted (e.g., 4 bits or 3 bits). The length of the subevent may mean the length of the same subevent before the updating of the primary event and the secondary event, and may be a value predetermined by the electronic device. The length of the subevent may be also referred to as, for example, subevent spacing.

According to an embodiment of the present disclosure, the electronic device may reduce the length of the primary subevent by the offset, increase the length of the primary subevent by the offset, and update the primary subevent and the secondary subevent. Accordingly, the primary subevent and the secondary subevent may not have the same length, and the amounts of data included in the primary subevent and the secondary subevent may be different.

In operation 1040, the electronic device may transmit the first data packets included in the updated first subevent and the updated second subevent to the external electronic device. The electronic device may transmit, to the external electronic device, data included in the CIS event including the first subevent and the second subevent having the length changed based on the offset. In this case, the amount of data included in the CIS event transmitted to the external electronic device may vary for each subevent in the CIS event. For example, the amount of data included in the first subevent in the CIS event may be greater than the amount of data included in the second subevent.

According to an embodiment of the present disclosure, the electronic device may receive, from the external electronic device, an acknowledgement (ACK) packet and a non-acknowledgement (NACK) packet corresponding to whether data packets have been received. When the packet received by the electronic device is the ACK packet, the subevent not including the data packets may enter into a rest state. For example, when audio data to be transmitted in the CIS 1 event is all received in the primary subevent and transmitted in FIG. 6 and an acknowledgement (ACK) is received according to the transmission of the data, the secondary subevent may enter into a rest state without receiving the audio data. In this case, the primary subevent may correspond to the first subevent and the secondary subevent may correspond to the second subevent. According to another embodiment of the present disclosure, when the packet received by the electronic device is a NACK packet, data packets indicated by the NACK packet may be configured as subevents and transmitted. For example, when audio data to be transmitted is all received in the primary subevent and a NACK for a specific payload is received in part (b) of FIG. 7, the secondary subevent may retransmit audio data which is to be transmitted and is indicated by the NACK. In this case, the primary subevent may correspond to the first subevent and the secondary subevent may correspond to the second subevent.

According to an embodiment of the present disclosure, the electronic device may identify second data packets by dividing the same to correspond to the number of subevents. The second data packets may mean data included in a CIS event different from the CIS event including the first data packets. For example, the data included in the CIS 0 event of FIG. 3 may correspond to the first data packets, and the data included in the CIS 1 event may correspond to the second data packets. Thereafter, the electronic device may identify at least one third subevent and at least one fourth subevent in the divided subevents. The third subevent may mean the primary subevent described in FIGS. 3 to 8, and the fourth subevent may mean, for example, the secondary subevent described in FIGS. 3 to 8. The electronic device may identify the third subevent and the fourth subevent to change the length among the respective subevents, in relation to the second data packets divided according to the preconfigured number of subevents. Thereafter, the electronic device may update, based on the offset, the at least one third subevent and the at least one fourth subevent.

The offset may mean, for example, the length of the subevent to receive data transferred from the third subevent to the fourth subevent. In addition, the offset may mean, for example, the secondary offset (SO) described in FIG. 3. The electronic device may transmit, to the external electronic device, the second data packets included in the updated third subevent and fourth subevent. The electronic device may transmit, to the external electronic device, data included in the CIS event including the third subevent and the fourth subevent each having a length changed based on the offset. In this case, the amount of data included in the CIS event transmitted to the external electronic device may vary for each subevent in the CIS event. For example, the amount of data included in the third subevent in the CIS event may be greater than the amount of data included in the fourth subevent.

According to an embodiment of the present disclosure, according to an electronic device and an operation method thereof, resource use can be efficiently performed through adaptive subevent change according to a format of the audio data. For example, all data packets to be transmitted may be included in one subevent, so that waste of resources for data transmission can be reduced, and complexity in a data format recombination and recoupling process can be reduced. In addition, when audio data is included in a variable subevent and transmitted, there may be a rest state corresponding to the subevent. Unnecessary waste of resources for data transmission can be reduced, a transmission success rate of audio data can be increased while maintaining low latency, and current consumption can be minimized.

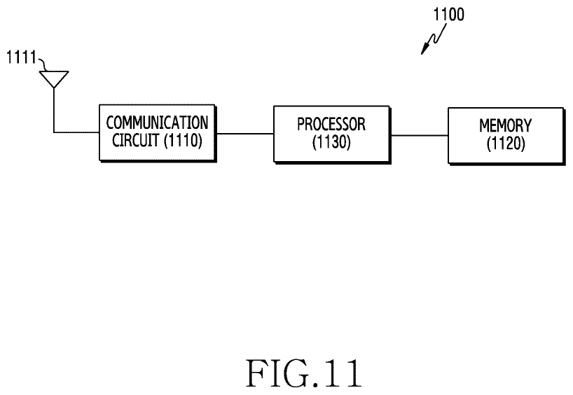

FIG. 11 illustrates a configuration of an electronic device according to an embodiment of the present disclosure.

Referring to FIG. 11, an electronic device 1100 according to an embodiment of the present disclosure may include a communication circuit 1110, an antenna module 1111, a memory 1120, and a processor 1130. However, the elements of the electronic device 1100 are not limited thereto, and only some of the above-described elements of FIG. 11 may be included, or one or more elements (e.g., an input module 150 and a display module 160) other than the above-described elements may be further included. In an embodiment, the electronic device 1100 may be the electronic device 101 of FIG. 1 and the electronic device 201 of FIG. 2. The electronic device 1100 of FIG. 11 may include an element identical or similar to at least one of the elements (e.g., modules) of the electronic device 101 of FIG. 1. Accordingly, the communication circuit 1110 may correspond to the communication module 190 or the wireless communication module 192 of FIG. 1, and the antenna module 1111 may correspond to the antenna module 197 of FIG. 1. In addition, the memory 1120 and the processor 1130 may correspond to the memory 130 and the processor 120 of FIG. 1, and when the electronic device 200 includes more elements, other elements may correspond to the elements of FIG. 1.

The communication circuit 1110 may support wireless communication between the electronic device 1100 and an external electronic device. For example, the communication circuit 1110 may transmit or receive a signal and/or data to and/or from the external electronic device by using a frequency band supported by wireless communication according to a specified wireless communication protocol. In an embodiment, the communication circuit 1110 may communicate with the external electronic device through a short-distance wireless communication network such as ultra-wideband (UWB), Bluetooth, Bluetooth low energy, wireless fidelity (Wi-Fi) direct, or infrared data association (IrDA). In an embodiment, the communication circuit 1110 is a wireless communication module, and may include a module for Bluetooth legacy communication and/or BLE communication. The communication circuit 1110 may be operated independently from the processor 1130, and may include one or more communication processors supporting wireless communication. In an embodiment, the communication circuit 1110 may be referred to as a communication interface or a communication module.

The antenna module 1111 may include multiple antennas, and at least one antenna suitable for a communication scheme used in a communication network (e.g., the first network 198 of FIG. 1) may be selected from among the multiple antennas by the communication circuit 1110.

The memory 1120 may store various information for the operation of the electronic device 1100. The information stored in the memory 1120 may include, for example, input data or output data for software and a command related thereto. In an embodiment, the information stored in the memory 1120 may include at least one instruction for an auxiliary operation of advertisement signal transmission for a BIS service. The instruction may correspond to the program 140 of FIG. 1. The instruction may be executed through the processor 1130, and upon execution of instructions by the processor 1130, the electronic device 1100 may perform operations according to an embodiment of the present disclosure. The memory 1120 may include volatile memory or non-volatile memory.

The processor 1130 may control at least one other element (e.g., a hardware or software element) of the electronic device 1100, and may perform various data processing or computation. The processor 1130 is at least a part of the data processing or computation, and the processor 1130 may load a command or data received from other elements (e.g., the communication circuit 1110) in the memory 1120, process the command or data stored in the memory 1120, and store result data in the memory 1120.

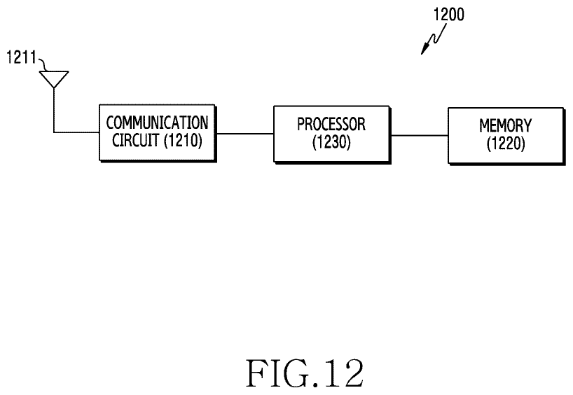

FIG. 12 illustrates elements of an external electronic device according to an embodiment of the present disclosure.

Referring to FIG. 12, an external electronic device 1200 according to an embodiment of the present disclosure may include a communication circuit 1210, an antenna module 1211, a memory 1220, and a processor 1230. However, the elements of the external electronic device 1200 are not limited thereto, and only some of the above-described elements of FIG. 12 may be included, or one or more elements other than the above-described elements may be further included. In an embodiment, the external electronic device 1200 of FIG. 12 may include an element identical or similar to at least one of the elements (e.g., modules) of the electronic device 101 of FIG. 1.

The communication circuit 1210 may support wireless communication between the external electronic device 1200 and the electronic device. For example, the communication circuit 1210 may transmit or receive a signal and/or data to and/or from the external electronic device by using a frequency band supported by wireless communication according to a specified wireless communication protocol. In an embodiment, the communication circuit 1210 may communicate with the external electronic device through a short-distance wireless communication network such as ultra-wideband (UWB), Bluetooth, Bluetooth low energy, wireless fidelity (Wi-Fi) direct, or infrared data association (IrDA). In an embodiment, the communication circuit 1210 is a wireless communication module, and may include a module for Bluetooth legacy communication and/or BLE communication. The communication circuit 1210 may be operated independently from the processor 1230, and may include one or more communication processors supporting wireless communication. In an embodiment, the communication circuit 1210 may be referred to as a communication interface or a communication module.

The antenna module 1211 may include multiple antennas, and at least one antenna suitable for a communication scheme used in a communication network (e.g., the first network 198 of FIG. 1) may be selected from among the multiple antennas by the communication circuit 1210.

The memory 1220 may store various information for the operation of the external electronic device 1200. The information stored in the memory 1220 may include, for example, input data or output data for software and a command related thereto. In an embodiment, the information stored in the memory 1220 may include at least one instruction for an auxiliary operation of advertisement signal transmission for a BIS service. The instruction may correspond to the program 140 of FIG. 1. The instruction may be executed through the processor 1230, and upon execution of instructions by the processor 1230, the external electronic device 1200 may perform operations according to an embodiment of the present disclosure. The memory 1220 may include volatile memory or non-volatile memory.

The processor 1230 may control at least one other element (e.g., a hardware or software element) of the external electronic device 1200, and may perform various data processing or computation. The processor 1230 is at least a part of the data processing or computation, and the processor 1230 may load a command or data received from other elements (e.g., the communication circuit 1210) in the memory 1220, process the command or data stored in the memory 1220, and store result data in the memory 1220.

As described above, an electronic device according to an embodiment disclosed herein may include a communication circuit configured to support Bluetooth low energy (BLE) communication, and at least one processor operatively connected to the communication circuit, wherein the at least one processor is configured to identify first data packets by dividing the same to correspond to the number of subevents, identify at least one first subevent and at least one second subevent in the divided subevents, update, based on an offset, the at least one first subevent and the at least one second subevent, and transmit, to an external electronic device, the first data packets included in the updated first subevent and the updated second subevent.

According to an embodiment disclosed herein, the at least one processor is configured to, in case that the number of subevents is an odd number, identify the first subevent and the second subevent with reference to a subevent in a middle order, and in case that the number of subevents is an even number, identify the first subevent and the second subevent with reference to a half of the number of the subevents.

According to an embodiment of the present disclosure, the offset may mean an amount of data transferred from the at least one second subevent to the at least one first subevent.

According to an embodiment of the present disclosure, the updated first subevent may mean a value obtained by adding the length of the offset to the length of the at least one first subevent, and the updated second subevent may mean a value obtained by subtracting the length of the offset from the length of the at least one second subevent.

According to an embodiment of the present disclosure, the length of the offset may be determined based on the length of the subevent, a partial ratio unit of the length of the subevent, and a target number of the partial ratio unit, and the length of the subevent and the number of subevents may be pre-configured values.

According to an embodiment of the present disclosure, the at least one processor may be configured to receive, from the external electronic device, an acknowledgement (ACK) packet or a non-acknowledgement (NACK) packet corresponding to whether data packets are received, in case that a received packet is the ACK packet, cause a subevent not including the data packets to enter into a rest state, and in case that the received packet is the NACK packet, configure data packets indicated by the NACK packet as the subevent and transmit the same.

According to an embodiment of the present disclosure, the at least one processor may be configured to identify second data packets by dividing the same to correspond to the number of subevents, identify at least one third subevent and at least one fourth subevent in the divided subevents, update, based on the offset, the at least one third subevent and the at least one fourth subevent, and transmit, to the external electronic device, the second data packets included in the updated third subevent and the updated fourth subevent.

According to an embodiment of the present disclosure, the first data packets and the second data packets may be subsequently arranged or are arranged to partially overlap each other.

According to an embodiment of the present disclosure, the first data packets may be included in a first connected isochronous stream (CIS) event, the first CIS event may include the updated first subevent and the updated second subevent, the second data packets may be included in a second CIS event, and the second CIS event may include the updated third subevent and the updated fourth subevent.

According to an embodiment of the present disclosure, the first CIS event and the second CIS event may be configured as one connected isochronous group (CIG) event.

According to an embodiment of the present disclosure, the second data packets may be configured as a second CIS, and the first data packets and the second data packets may be configured as one connected isochronous group (CIG).

As described above, a method performed by an electronic device according to an embodiment of the present disclosure may include identifying first data packets by dividing the same to correspond to the number of subevents, identifying at least one first subevent and at least one second subevent in the divided subevents, updating, based on an offset, the at least one first subevent and the at least one second subevent, and transmitting, to an external electronic device, the first data packets included in the updated first subevent and the updated second subevent.

According to an embodiment of the present disclosure, the identifying of the first subevent and the at least one second subevent may further include in case that the number of subevents is an odd number, identifying the first subevent and the second subevent with reference to a subevent in a middle order, and in case that the number of subevents is an even number, identifying the first subevent and the second subevent with reference to a half of the number of the subevents.

According to an embodiment of the present disclosure, the offset may mean an amount of data transferred from the at least one second subevent to the at least one first subevent.

According to an embodiment of the present disclosure, the updated first subevent may mean a value obtained by adding the length of the offset to the length of the at least one first subevent, and the updated second subevent may mean a value obtained by subtracting the length of the offset from the length of the at least one second subevent.

According to an embodiment of the present disclosure, the length of the offset may be determined based on the length of the subevent, a partial ratio unit of the length of the subevent, and a target number of the partial ratio unit, and the length of the subevent and the number of subevents may be pre-configured values.

According to an embodiment of the present disclosure, the method may include receiving, from the external electronic device, an acknowledgement (ACK) packet or a non-acknowledgement (NACK) packet corresponding to whether data packets are received, in case that a received packet is the ACK packet, causing a subevent not including the data packets to enter into a rest state, and in case that the received packet is the NACK packet, configuring data packets indicated by the NACK packet as the subevent and transmitting the same.

According to an embodiment of the present disclosure, the method may include identifying second data packets by dividing the same to correspond to the number of subevents, identifying at least one third subevent and at least one fourth subevent in the divided subevents, updating, based on the offset, the at least one third subevent and the at least one fourth subevent, and transmitting, to the external electronic device, the second data packets included in the updated third subevent and the updated fourth subevent.

According to an embodiment of the present disclosure, the first data packets and the second data packets may be subsequently arranged or are arranged to partially overlap each other.

According to an embodiment of the present disclosure, the first data packets may be included in a first connected isochronous stream (CIS) event, the first CIS event may include the updated first subevent and the updated second subevent, the second data packets may be included in a second CIS event, and the second CIS event may include the updated third subevent and the updated fourth subevent.

According to an embodiment of the present disclosure, the first CIS event and the second CIS event may be configured as one connected isochronous group (CIG) event.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device comprising:
a communication circuit configured to support a Bluetooth low energy (BLE) communication; and
at least one processor operatively coupled with the communication circuit, the at least one processor configured to:
identify first data packets by dividing the first data packets into a number of subevents, identify at least one first subevent and at least one second subevent from the divided subevents,
update, based on an offset, the at least one first subevent and the at least one second subevent, wherein the at least one updated first subevent and the at least one updated second subevent include the first data packets, and
transmit, to an external electronic device, the first data packets included in the updated first subevent and the updated second subevent.

2. The electronic device of claim 1, wherein the at least one processor is further configured to:
in case that the number of subevents is configured as an odd number, identify the first subevent and the second subevent with a reference to a subevent in a middle order; and
in case that the number of subevents is configured as an even number, identify the first subevent and the second subevent with a reference to a half of the number of the subevents.

3. The electronic device of claim 1, wherein the offset indicates an amount of data transferred from the at least one second subevent to the at least one first subevent.

4. The electronic device of claim 3, wherein the updated first subevent indicates a value identified by adding a length of the offset to a length of the at least one first subevent, and
wherein the updated second subevent indicates a value identified by subtracting the length of the offset from a length of the at least one second subevent.

5. The electronic device of claim 4, wherein the length of the offset is identified based on the length of the subevent, a partial ratio unit of the length of the subevent, and a target number of the partial ratio unit, and
wherein the length of the subevent and the number of subevents are pre-configured.

6. The electronic device of claim 1, wherein the at least one processor is further configured to:
receive, from the external electronic device, an acknowledgement (ACK) packet or a non-acknowledgement (NACK) packet based on whether data packets are received;
in case that a received packet is the ACK packet, enter into a rest state for a subevent not comprising the data packets; and
in case that the received packet is the NACK packet, configure the data packets indicated by the NACK packet as the subevent and transmit the configured data packets.

7. The electronic device of claim 1, wherein the at least one processor is further configured to:
identify second data packets by dividing the second data packets to correspond to the number of subevents;
identify at least one third subevent and at least one fourth subevent from the divided subevents;
update, based on the offset, the at least one third subevent and the at least one fourth subevent, wherein the updated third subevent and the updated fourth subevent includes the second data packets; and
transmit, to the external electronic device, the second data packets included in the updated third subevent and the updated fourth subevent.

8. The electronic device of claim 7, wherein:
the first data packets and the second data packets are subsequently arranged; or
the first data packets and the second data packets are arranged to partially overlap each other.

9. The electronic device of claim 7, wherein:
the first data packets are included in a first connected isochronous stream (CIS) event;
the first CIS event comprises the updated first subevent and the updated second subevent;
the second data packets are included in a second CIS event; and
the second CIS event comprises the updated third subevent and the updated fourth subevent.

10. The electronic device of claim 9, wherein the first CIS event and the second CIS event are configured as a connected isochronous group (CIG) event.

11. A method performed by an electronic device, the method comprising:
identifying first data packets by dividing the first data packets to correspond to a number of subevents;
identifying at least one first subevent and at least one second subevent from the divided subevents;
updating, based on an offset, the at least one first subevent and the at least one second subevent based on an offset, wherein the at least one updated first subevent and the at least one updated second subevent include the first data packets; and
transmitting, to an external electronic device, the first data packets included in the updated first subevent and the updated second subevent.

12. The method of claim 11, wherein identifying the first subevent and the at least one second subevent comprises:
in case that the number of subevents is configured as an odd number, identifying the first subevent and the second subevent with a reference to a subevent in a middle order; and
in case that the number of subevents is configured as an even number, identifying the first subevent and the second subevent with a reference to a half of the number of the subevents.

13. The method of claim 11, wherein the offset indicates an amount of data transferred from the at least one second subevent to the at least one first subevent.

14. The method of claim 13, wherein the updated first subevent indicates a value identified by adding a length of the offset to a length of the at least one first subevent, and
wherein the updated second subevent indicates a value identified by subtracting the length of the offset from a length of the at least one second subevent.

15. The method of claim 14, wherein the length of the offset is identified based on the length of the subevent, a partial ratio unit of the length of the subevent, and a target number of the partial ratio unit, and
wherein the length of the subevent and the number of subevents are pre-configured values.

16. The method of claim 11, further comprising:
receiving, from the external electronic device, an acknowledgement (ACK) packet or a non-acknowledgement (NACK) packet based on whether data packets are received;
in case that a received packet is the ACK packet, entering into a rest state for a subevent not comprising the data packets; and
in case that the received packet is the NACK packet, configuring the data packets indicated by the NACK packet as the subevent and transmitting the configured data packets.

17. The method of claim 11, further comprising:
identifying second data packets by dividing the second data packets to correspond to the number of subevents;
identifying at least one third subevent and at least one fourth subevent from the divided subevents;
updating, based on the offset, the at least one third subevent and the at least one fourth subevent, wherein the updated third subevent and the updated fourth subevent includes the second data packets; and
transmitting, to the external electronic device, the second data packets included in the updated third subevent and the updated fourth subevent.

18. The method of claim 17, wherein:
the first data packets and the second data packets are subsequently arranged; or
the first data packets and the second data packets are arranged to partially overlap each other.

19. The method of claim 17, wherein:
the first data packets are included in a first connected isochronous stream (CIS) event;
the first CIS event comprises the updated first subevent and the updated second subevent;
the second data packets are included in a second CIS event; and
the second CIS event comprises the updated third subevent and the updated fourth subevent.

20. The method of claim 19, wherein the first CIS event and the second CIS event are configured as a connected isochronous group (CIG) event.
